(19) United States
(12) Patent Application Publication
(10) Pub. No.: US 2008/0127562 A1
(43) Pub. Date: Jun. 5, 2008

(54) Door Drive, in Particular for a Revolving Door

(75) Inventor: Volker Bienek, Dortmund (DE)

Correspondence Address: COHEN, PONTANI, LIEBERMAN & PAVANE, 551 FIFTH AVENUE, SUITE 1210, NEW YORK, NY, 10176, US

(73) Assignee: Dorma GmbH + Co. KG, Ennepetal (DE)

(21) Appl. No.: 11/793,275

(22) PCT Filed: Nov. 11, 2005
(86) PCT No.: PCT/EP05/12082

§ 371 Date: Jun. 18, 2007

(30) Foreign Application Priority Data
Dec. 17, 2004 (DE) 10 2004 061 621.3

(51) Int. Cl. E05F 15/04

(52) U.S. Cl. 49/334

(57) ABSTRACT

A door operator includes a housing having a reception compartment, a pressure compartment, a hydraulic compartment providing a reservoir volume, a drive unit disposed in the reception compartment and coupleable to a door via an output shaft, a hydraulic pump in hydraulic connection with the pressure compartment and the hydraulic compartment, a motor in driving relationship with the hydraulic pump, and a spring force accumulator disposed in the housing. The spring force accumulator is associated with the pressure compartment and coupled to the drive unit. The reception compartment has an area having a diameter greater than a diameter of any other area of the reception compartment, and the drive unit is disposed in the area.

The invention relates to a door operator, in particular a swing door operator according to the generic part of patent claim 1.

Such a door operator is known from DE 295 21 068 U1. An overhead door closer with a slide rail linkage is known from DE 40 38 720 C2, which has a cam drive unit allowing for an optimum door moment curve and a comfortable operation. In principle this overhead door closer would be therefore suitable as a door operator as well; however, experiments conducted during the course of the invention have shown that applying oil pressure to the drive unit results in a very unfavourable transformation of the hydraulic pressure in the resulting movement of stroke/rotation and repeated stroke. Since about 75% of the output capacity to be applied is required for loading the spring force accumulator of such door closer, whereas only about 25% of the output capacity needs to be delivered by the system for accelerating the door. As it is furthermore desirable to keep the narrow structural shape of such a door closer for door operators as well, the dimensions of the structural components cannot be adapted to the extremely high load. Thus, although functionally and technically advantageous, the known overhead door closer is not suitable as a door operator.

Another swing door operator is known from DE 197 56 496 C2. This swing door operator has an electromechanical drive unit, which is provided with a drive motor and a gear and with a subsequent power transmission unit for the connected door. The power transmission unit has a spindle with a spindle nut partially overlapping the former, which spindle is non-positively and positively connected to a toothed rack. Although this swing door operator can be installed concealed, the door moment curve is not as optimal as with the above described door closers having the cam technology. On account of their dimension, these door closers need to be accommodated in special profiles.

Therefore, it is the object of the present invention to provide a door operator of the species indicated in the generic part of patent claim 1, which can be installed completely concealed within the door profile or frame profile, and does not require any special constructions of the door system.

This problem is solved by the features of patent claim 1.

On account of its compact structure, the inventive door operator allows for a concealed installation within a door profile or a frame profile and thus allows for a total integration with the door system.

Particularly the installation in common narrow door profiles is possible.

As an advantage, neither special door profiles nor any special constructions, which would interfere with the design of the door system, are necessary. Another advantage results from an economical mounting combined with a wide applicability and it is moreover possible to retrofit existing door systems with the inventive door operator. Another advantage results from the fact that, with the inventive door operator, a direct introduction of force for loading a spring force accumulator is possible. Therefore, the possibility is given of avoiding unnecessary stress of the mechanical structural components.

At first the inventive construction allows for a very compact design, and it is possible to directly utilize the major portion of the total output capacity without redirection for pre-loading the spring force accumulator. Therefore, there is no unnecessary stress on structural components, nor load on bearings, nor any loss on account of friction nor loss of efficiency. Through disposing a cam plate assembly, with a single cam plate being disposed in the largest diameter range, a mechanical tension-compression connection is created, which, in conjunction with the force transmission rollers, allows to precisely guide the cam disc on the output shaft. Through this structural measure, the disposition is particularly suitable for realizing hold-open functions, or controlled free-wheeling functions.

By providing preferably provided specific hydraulic controls, such as through the use of a solenoid valve, further hydraulic functions such as free-wheeling, hydraulic hold-open or hydraulic closing sequence control are made possible.

Furthermore, it is possible to realize a hydraulic opening damping and to use differently built drive units.

Advantageous further developments of the invention are the subject matter of the dependent claims.

Further details, features and advantages of the invention will become apparent from the following description of exemplary embodiments, reference being made to the drawings, in which:

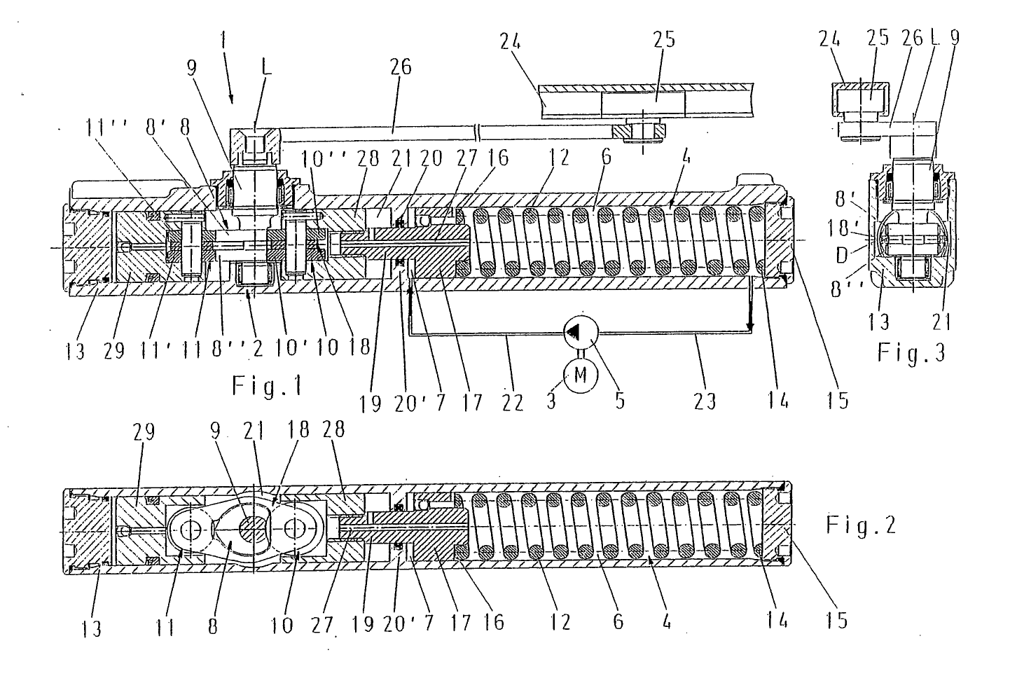

FIG. 1 shows a diagrammatically simplified basic illustration of an embodiment of an inventive door operator,

FIG. 2 shows a sectional top view on the door operator according to FIG. 1.

FIG. 3 shows a vertical section through the door operator according to FIG. 1 in the area of the output shaft,

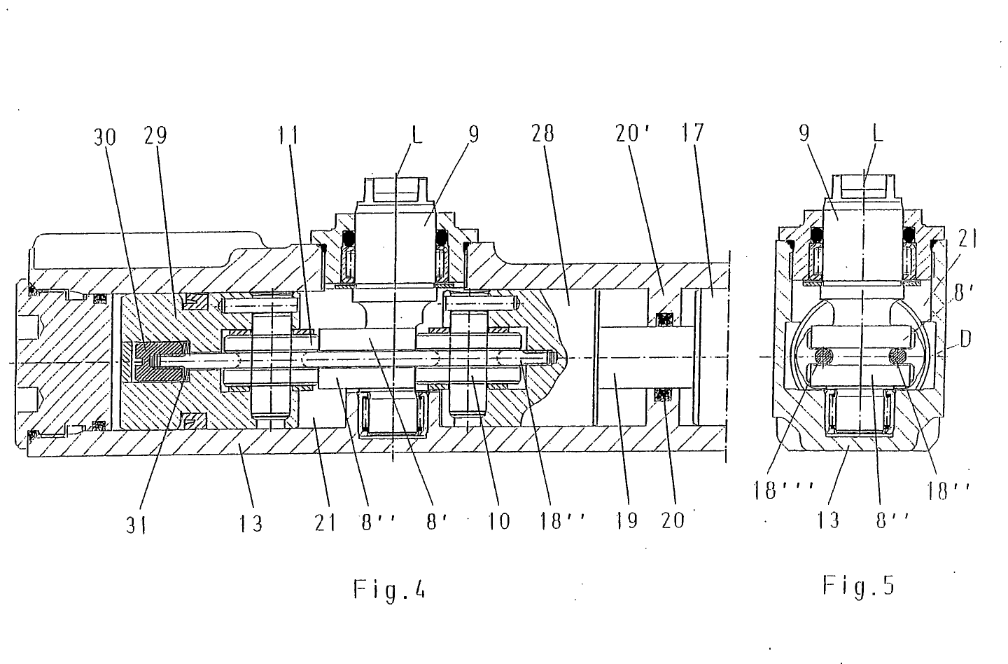

FIG. 4: shows an illustration of the door operator enlarged in scale, corresponding to FIG. 1, in the area of the output shaft, and

FIG. 5: shows an illustration of the door operator enlarged in scale, corresponding to FIG. 3, in the area of the output shaft.

FIG. 1 shows an inventive door operator 1, which in particular can be executed as a swing door operator. The door operator 1 has a drive unit 2, which, via an output shaft 9, can be coupled to a door not illustrated in FIG. 1, for example via a lever 26 and a slide channel 24 with a sliding member 25. The drive unit 2 is disposed in a housing 13.

Furthermore, the door operator 1 has a motor 3, as well as a spring force accumulator 4 disposed in the housing 13, which accumulator is coupled to the motor 3 and the drive unit 2.

As depicted in FIG. 1, the motor 3 is in driving connection with a hydraulic pump 5. In this case, the motor 3 and the pump 5 can be flange-mounted to the housing 13. Via the hydraulic pump 5 and a first hydraulic line 22, the motor 3 is in hydraulic connection with a pressure compartment 7. Via a second hydraulic line 23, the motor 3 and the pump 5 are in hydraulic connection with a pressure compartment 6, which forms a reservoir volume, and wherein a compression spring 12 of the spring force accumulator 4 is disposed.

In the embodiment illustrated in FIG. 1, the drive unit 2 is formed as a cam drive. This cam drive has a cam disc 8, which is disposed on the output shaft 9. The cam disc 8 cooperates with two force transmission rollers 10 and 11, which are disposed on both sides of the output shaft 9 and bear on cam paths of the cam disc 8.

As depicted in FIG. 1, a spring loading piston 17, which directly introduces the force for loading the compression spring 12 into the latter, is disposed in the pressure compartment 7. The spring loading piston 17 is connected to the opening piston 28 and to a cam plate assembly 18 of the drive unit 2, via a piston rod 19, which, by means of the joint 20, passes in a sealing manner through the separating wall 20′.

Furthermore, FIG. 1 shows that one end 14 of the spring 12 bears against a housing wall 15 of the housing 13, whereas the other end 16 bears against the spring loading piston 17.

As FIG. 1 reveals, this division of the pressure compartments first of all allows for utilizing the advantages of the cam technology, preferably through suitable hydraulic controls (solenoid valves, throttles or the like). The set-up between the spring and the cam drive is extremely decisive, as only this allows for direct loading of the spring. A further result is the extremely compact design explained at the beginning, which makes a completely concealed installation in door profiles or frame profiles possible.

FIG. 2 shows a top view on the door operator 1 according to FIG. 1 in the area of the output shaft 9. This top view reveals that the force transmission rollers 10, 11 are disposed on a cam plate assembly 18, which is connected to the spring loading piston 17 via the piston rod 19. Between the hydraulic compartment 6 and a reception compartment 21, an axial pressure compensation bore 17 extends through the piston rod 19 and the spring loading piston 17.

FIG. 3 reveals that the cam disc 8 is divided into two cam discs 8′, 8″, which are disposed towards each other and spaced apart along a longitudinal axis L of the output shaft 9. These cam discs 8′, 8″ cooperate with two individual rollers 10′, 10″ or 11′, 11″ of the force transmission rollers 10, 11, correspondingly disposed towards each other and spaced apart.

On account of this division, it is possible to dispose the cam plate assembly 18 in the area of the largest diameter D between the individual rollers 10′, 10″, 11′, 11″ and the associated cam discs 8′, 8″. This disposition is advantageous in that it offers the largest diameter without the necessity to enlarge the reception compartment 21, such that the exterior dimensions of the door operator 1 can remain unaffected. Furthermore, the central disposition avoids bending stress in the cam plate. At the same time, the cam plate assembly realizes a torsion protection for the piston.

As illustrated in FIGS. 2 and 3, the cam plate assembly 18 can be formed as an individual cam plate 18′.

FIGS. 4 and 5 show an alternative embodiment wherein the cam plate assembly is formed by pairs of bolts 18″, 18′″, which can be fixed via appropriated bolt attachments. The cam plates or the bolts form, in this case, a tension-compression connection between the pistons. Springs can be saved through this disposition. That is in particular a spring for pressing the force transmission roller 11 against the cam disc 8 via the damping piston 29.

Moreover, in this disposition the lateral guidance of the bolts 18″ and 18′″ along the output shaft 9 or between the cam discs 8′ and 8″ achieves a torsion protection for the opening piston 28 and for the damping piston 29.

Furthermore, by utilizing nuts 30, which are disposed in the damping piston 29 and loaded by springs 31, a clearance-free disposition can be realized between the force transmission rollers 10, 11 and the cam disc 8′ and 8″, without using a cam plate assembly.

Such a clearance-free disposition is of great benefit for an optimal hold-open function of such a drive.

### LIST OF REFERENCES

1 door operator
2 drive unit
3 motor
4 spring force accumulator
5 hydraulic pump
6 pressure compartment (drive unit)
7 pressure compartment (spring force accumulator)
8 cam disc
8′ cam disc
8″ cam disc
9 output shaft
10 force transmission rollers
10′ roller
10″ roller
11 force transmission rollers
11′ roller
11″ roller
12 compression spring
13 housing
14 end
15 housing wall
16 end
17 spring loading piston
18 cam plate assembly
18′ individual cam plate
18″ pair of bolts
18′″ pair of bolts
19 piston rod
20 joint
20′ separating wall
21 reception compartment
22 first hydraulic line
23 second hydraulic line
24 slide channel
25 sliding member
26 lever
27 compensating bore
28 opening piston
29 damping piston
30 counter nut
31 clearance compensating spring
D diameter
L longitudinal axis

1.-11. (canceled)

12. A door operator comprising:
a housing defining a reception compartment with an area of greatest diameter and a hydraulic compartment providing a reservoir volume;
a drive unit disposed in the area of greatest diameter of the reception compartment and coupleable to a door via an output shaft;
a spring force accumulator disposed in the housing, the spring force accumulator being associated with a pressure compartment in the housing and coupled to the drive unit;
a hydraulic pump in hydraulic connection with the pressure compartment and the hydraulic compartment; and
a motor in driving relationship with the hydraulic pump.

13. The door operator of claim 12, wherein the drive unit comprises a cam drive comprising a cam disc mounted on the output shaft and first and second force transmission rollers disposed on two sides of the output shaft and bearing on cam paths of the cam disc.

14. The door operator of claim 12, wherein the spring force accumulator comprises a spring loading piston and a compression spring, the compression spring having a first end bearing against a wall of the housing, and a second end bearing against the spring loading piston.

15. The door operator of claim 14, wherein the pressure compartment is disposed adjacent to and acts on spring loading piston.

16. The door operator of claim 14, further comprising a piston rod, the drive unit further comprising a cam plate assembly which is connected to the spring loading piston via the piston rod, the first and second force transmission rollers being mounted on the cam plate assembly.

17. The door operator of claim 16, wherein the housing has a separating wall and a seal in the separating wall, the piston rod extending through the seal.

18. The door operator of claim 13, wherein the cam disc comprises two spaced cam disc elements, the first force transmission roller comprising two spaced rollers cooperating with the respective cam disc elements, the second force transmission roller comprising two spaced rollers cooperating with the respective cam disc elements.

19. The door operator of claim 16, wherein the cam plate assembly comprises a cam plate.

20. The door operator of claim 16, wherein the cam plate assembly comprises a pair of bolts.

21. The door operator of claim 13, wherein a clearance compensation is provided between the cam disc and at least one of the first and second force transmission rollers.

22. The door operator of claim 12, wherein the door operator is a swing door operator.
